(19) United States
(12) Patent Application Publication
(10) Pub. No.: US 2020/0168123 A1
(43) Pub. Date: May 28, 2020

(54) CLINICAL DENTAL EDUCATION AND TRAINING SYSTEM AND METHOD

(71) Applicant: EPED Inc., Kaohsiung City (TW)

(72) Inventors: Ta-Ko Huang, Kaohsiung City (TW); Jerry T. Huang, Kaohsiung City (TW)

(21) Appl. No.: 16/697,432

(22) Filed: Nov. 27, 2019

(30) Foreign Application Priority Data
Nov. 27, 2018 (TW) 107142302

(51) Int. Cl. G09B 23/28; G09B 19/24

(52) U.S. Cl. CPC G09B 23/283; G09B 19/24

(57) ABSTRACT

Disclosed is a clinical dental education and training method. The method collects and records a learner's operating conduct during learning or related data during a dental surgery practice, and generates an analysis result by various operating indexes of a data analysis, and provides the analysis result for the learner to know if there is any deficiency of the learner during the operation process, so as to enhance technical deficiency and improve teaching performance.

### BACKGROUND OF INVENTION

### Field of Invention

The present disclosure relates to an education and training system, and more particularly to a clinical dental education and training system capable of instantly recording the operation process and generating result data accordingly.

### Description of the Related Art

In present dental teaching and training systems, learners directly perform a dental operation to a dental model of a dummy used for dental teaching, but such teaching method cannot evaluate the learners' performance during the dental operation process. For example, an alveolar bone is drilled with an improper depth, a tooth is drilled and formed into an improper shape, a pulp inside the tooth is damaged during the operation process, or a force with an improper angle is applied to the alveolar bone or tooth, and all of the above situations will cause sequelae after the dental operation. However, it is impossible to conduct evaluation and analysis related of the factors of the above situations during the learning and operation processes through a data-based method except by a teacher's visual examination and guidance, so that the learners can only gain experience from practical operations in the future, and such learning method is quite dangerous to patients.

### SUMMARY OF THE INVENTION

Therefore, it is a primary objective of this disclosure to provide a clinical dental education and training system and its method, and the system collects related data of a learner's learning behavior during a clinic operation and examines the details of the learner's operation during the learning process by system analysis, scan analysis or AI analysis, and then provides recommendations accordingly to overcome the drawbacks of the conventional operation process. In addition, the system and method of this disclosure have the effects of improving the skill of dental learners, objectively evaluating the teaching performance or index, and providing an evaluation system for the dental education and training.

To achieve the aforementioned and other objectives, this disclosure provides a clinical dental education and training system comprising a handheld positioning portion, a positioning plate, an image tracking and capturing system and a server. The handheld positioning portion comprises a plurality of first positioning marks and is coupled to a drill portion, and the first positioning marks are disposed on the handheld positioning portion and relative to the other side of the drill portion. The positioning plate comprises a plurality of second positioning marks and a bracket, wherein, the bracket is combined with a dental model, so that the positioning plate is fixed in a detection area of the image tracking and capturing device to track the position of the dental model. The image tracking and capturing system obtains the positions of the first positioning marks and converts such positions into a plurality of first positioning signals and also obtains the positions of the second positioning marks and converts such positions into a plurality of second positioning signals. The server pre-stores image data of the dental model and is coupled to the image tracking and capturing system via a signal to obtain the first positioning signals and the second positioning signals and to convert the first positioning signals and the second positioning signals into a plurality of operation signals, and then to analyze and compare the operation signals with the pre-stored course data to generate operational scores and operational error data. The clinical dental education and training system of this disclosure can collect a learner's operation process and generate course data and evaluation scores which are fed back to the learner in order to improve the learner's technical deficiencies.

Preferably, the clinical dental education and training system of this disclosure is capable of storing teaching data and displaying a teaching image included in the teaching data on the screen and provided to the user for a guidance operation. Therefore, this system can guide users to make reasonable determination or decision and can further provide three-dimensional teaching images or other information to assist the users' operation.

Further, the server generates operational scores or operational error data according to the difference between the operation signals and the course data, or performs a path comparison and converts their difference into operational scores or operational error data.

Further, the server is coupled to a scanning device, wherein the scanning device is provided for scanning an operated dental model and transmitting the scan result to the server, so that the server can perform the analysis and evaluation according to the result.

To achieve the aforementioned and other objectives, this disclosure further provides a clinical dental education and training method. Firstly, an image tracking and capturing system is used to obtain positions of a plurality of first positioning marks of a handheld positioning portion and positions of a plurality of second positioning marks of a positioning plate, wherein the first positioning marks are coupled to a drill portion of the handheld positioning portion. The positions of the first positioning marks are converted into a plurality of first positioning signals, and the positions of the second positioning marks are converted into a plurality of second positioning signals. The first positioning signals and the second positioning signals are obtained by the image tracking and capturing system and stored into a server, and the server converts the first positioning signals and the second positioning signals into a plurality of operation signals. The operation signals are analyzed and compared with the stored course data to generate operational scores and operational error data. The clinical dental education and training method of this disclosure collects a learner's operation process and generate course data and evaluation scores accordingly. Therefore, this method is capable of providing an objective comparison standard to teachers and learners, and focusing the operational learning data with a weaker operation (or a relatively higher error rate) to users in order to improve their technical deficiencies.

Preferably, the clinical dental education and training method of this disclosure further comprises the steps of obtaining teaching data and displaying a teaching image included in the teaching data on a screen and provided to users for a guidance operation. Therefore, this system can guide users to make reasonable determination and decision and provide teaching images or other information to assist the users' operation.

### BRIEF DESCRIPTION OF THE DRAWINGS

FIG. 1 is a schematic view of a clinical dental education and training system in accordance with a first embodiment of this disclosure;

FIG. 2 is a functional block diagram of a server in accordance with an embodiment of this disclosure;

FIG. 3 is a flow chart of a clinical dental education and training method in accordance with an embodiment of this disclosure;

FIG. 4 is a schematic view of a clinical dental education and training system in accordance with an embodiment of this disclosure; and

FIG. 5 is a schematic view of a clinical dental education and training system in accordance with a second embodiment of this disclosure.

### DESCRIPTION OF THE PREFERRED EMBODIMENTS

The present invention will become clearer in light of the following detailed description of an illustrative embodiment of this invention described in connection with the drawings. Only some embodiments of the present invention have been illustrated in the drawings, but it should be pointed out that many other modifications are conceivable within the scope of the following claims.

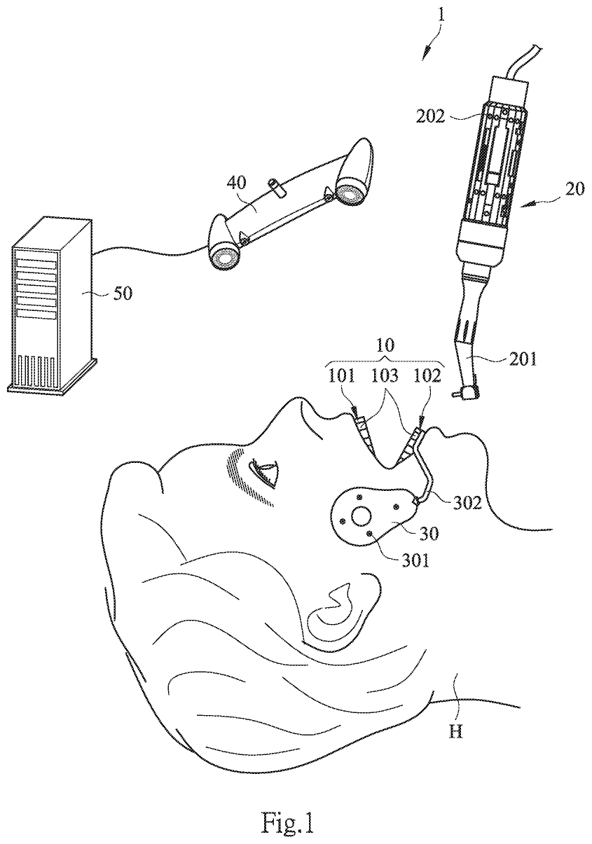

With reference to FIG. 1 for a schematic view of a clinical dental education and training system in accordance with the first embodiment of this disclosure, the clinical dental education and training system 1 comprises a dental model 10 of a head model H, a handheld positioning portion 20, a positioning plate 30, an image tracking and capturing system 40, and a server 50. The dental model 10 further comprises an upper-jaw mold 101 and a lower-j aw mold 102, and both of the upper-jaw mold 101 and the lower-jaw mold 102 include a plurality of dental model bodies 103. The handheld positioning portion 20 includes a plurality of positioning marks 202 coupled to a drill portion 201, and these positioning marks 202 are formed on opposite sides of the drill portion 201 and provided for the image tracking and capturing device to track positions. The positioning plate 30 includes a plurality of positioning marks 301 and a bracket 302. The bracket 302 is coupled to the dental model 10, such that the positioning marks 301 of the positioning plate 30 are fixed in a detection area of a head model H. In addition, the bracket 302 is coupled to link with the upper-jaw mold 101 or the lower-jaw mold 102, so that the image tracking and capturing system 40 can confirm the current position of the dental model 10 to achieve the effect of obtaining the relative position status of the handheld positioning portion 20 with respect to the dental model 10.

In an embodiment of this disclosure, the image tracking and capturing system 40 can obtain a plurality of first positioning signals of the handheld positioning portion 20 and a plurality of second positioning signals of the positioning plate 30. In an embodiment, the first positioning signals may be a plurality of first tracking signals transmitted from the positioning marks 202, and the second positioning signals may be a plurality of second tracking signals transmitted from the positioning marks 301. In another embodiment, the first positioning signals may be the first tracking signals transmitted from the image tracking and capturing system 40 to the positioning marks 202 and reflected from the positioning marks 202, and the second positioning signals may be the second tracking signals transmitted from the image tracking and capturing system 40 to the positioning marks 301 and reflected from the positioning marks 301. In another embodiment, the first positioning signals may be visible light or invisible light emitted actively from the positioning marks 202, and the second positioning signals may be a visible light or an invisible light emitted actively from the positioning marks 301. In a time interval, the first positioning signals may be connected to form path information, and it indicates a motion path of an operator who is holding the handheld positioning portion 20.

In another embodiment, the image tracking and capturing system 40 may further be configured to instantly obtain image data of the dental model 10 and a plurality of relative position signals between the handheld positioning portion 20 and the positioning plate 30 according to the image data of the dental model 10 as well as the first positioning signals and the second positioning signals.

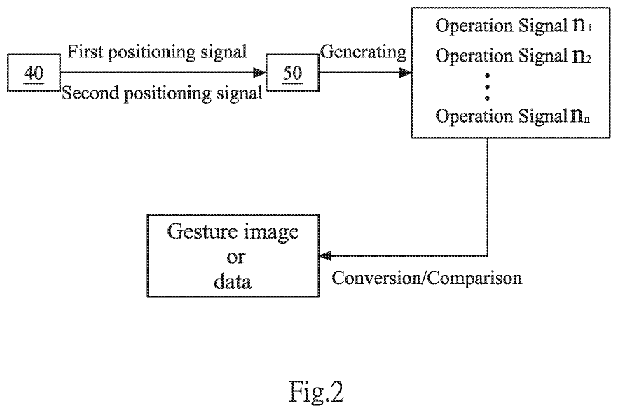

With FIG. 2 for a functional block diagram of a server 50 of this disclosure, the server 50 is telecommunicatively coupled to the image tracking and capturing system 40 and provided for obtaining the first positioning signals and the second positioning signals from the image tracking and capturing system 40 and converting the first positioning signals and the second positioning signals into a plurality of operation signals N₁, N₂, . . . Nₘ.

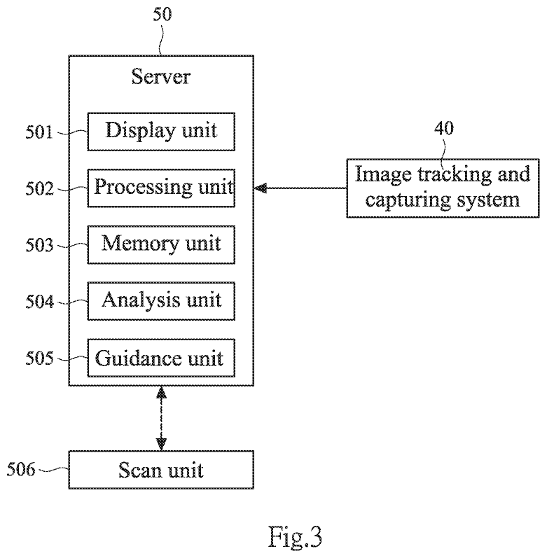

In FIG. 3, the server 50 comprises a display unit 501, a processing unit 502, a memory unit 503, an analysis unit 504 and a guide unit 505. The processing unit 502 is provided for obtaining the first positioning signals and the second positioning signals from the image tracking and capturing system 40 and converting the first positioning signals, the second positioning signals and the relative position signals into the operation signals N₁, N₂, . . . Nₘ. The operation signals are converted into a plurality of corresponding operation images which are provided to users/learners to examine their clinical operation gesture.

The memory unit 503 is telecommunicatively coupled to the processing unit 502 and provided for storing the first positioning signals, the second positioning signals and the operation signals. The analysis unit 504 obtains the operation signals generated according to the user's operating conduct (such as a moving path or a drilling angle) from the memory unit 503, and data analysis or various algorithms of an artificial intelligence (AI) system are used to analyze and compare the operation signal with the course data (such as a standard operation method or a recommended operation method) stored in the memory unit 503, and operational scores and operational error data (such as wrong drilling positions) are generated after the analysis, and then the operational scores are stored into the memory unit 503 may be transmitted to the display unit 501 for a display according to an instruction. The operational error data may be display in form of texts, simulated images, or data on the display unit 501, so that the operator can know the related problem or mistake easily to achieve the effect of improving the technical skills.

The processing unit 502 can further obtain teaching data from the memory unit 503 and display a teaching image included in the teaching data on the display unit 501, so that the operator can practice a surgical operation based on the teaching image of the teaching data, or the processing unit 502 is coupled to a guide module 505 via a signal, and the guide module 505 may be a general display device, a three-dimensional image display device or an indicating lamp. The general display device or three-dimensional image display device is provided for playing the image, and the indicating lamp is provided for indicating a specific position by direct illumination to achieve an instant guidance effect. Both of the course data and the teaching data include a dental cast analysis or selection, a drill analysis and selection, an operation flow, a dental model turning, etc.

The description of the following model is provided to select an optimal drill. By collecting data such as the model number of the drill and the sequence of selected use during the user's turning, an AI system data analysis can explore the turning of a learner in a course. After the learner has practiced the turning for several times, the information including the trend of drill selection, the change of scores, the turning time, etc. will be fed back to the learner as a reference for further corrections and technical skill improvements. For example, in the first time, five types of drills 1, 2, 3, 4, 5 are used in a course A, and the time consumed is 60 minutes, and a score of 80 is obtained. In the second time, three types of drills 1, 3, 5 are used in the same course A, and the time consumed is 50 minutes, and a score of 70 is obtained. In the third time, four types of drills 1, 3, 4, 5 are used in the same course A, and the time consumed is 50 minutes, and a score of 85 is obtained. Therefore, a balance between the turning consumed time and the selection of drills is obtained. Wherein, the relationship between the time, the type of drills and the score can be calculated by an algorithm according to the mutual relation between parameters in order to obtain a corresponding grade. However, the grade is just a basis for judgment only, but not a comprehensive evaluation. The grade represents a distance from the standard operation with good or bad performance in a certain area or a mutual comparison result between groups. In addition, the AI system data can be used to determine or analyze a learner's clinical operation gesture by the algorithm to obtain a custom gesture and path of the learner, so as to determine the reasons of the learner's wrong operation that may occur during the clinical operation, and to provide recommendations for corrections and the best operating mode. Further, this recorded data can be derived to custom data of the learner in the future. In other words, the learner just needs to retrieve the related data of the learner from the system automatically when the learner needs to perform a corresponding surgical operation, and the system can arrange related mechanical equipment to a position which does not interfere with the learner or affect the operation of the equipment according to the learner's custom gesture. In addition, these data are used as a basis for system login to reduce the possibility of various human errors and improve safety.

Further, a scanning device is integrated to the system for scanning a patient's teeth after the clinical operation and the scan result is analyzed and compared with a standard pre-stored in the server, so as to generate a variance analysis result accordingly, and this variance analysis result is used to determine whether or not the scan result falls in a pass range by an algorithm, a proportional analysis, or an appearance analysis. The server may also be integrated with gesture analysis and result analysis to obtain a comprehensive judgment result, so as to avoid neglecting other possibility due to a limitation by existing knowledge.

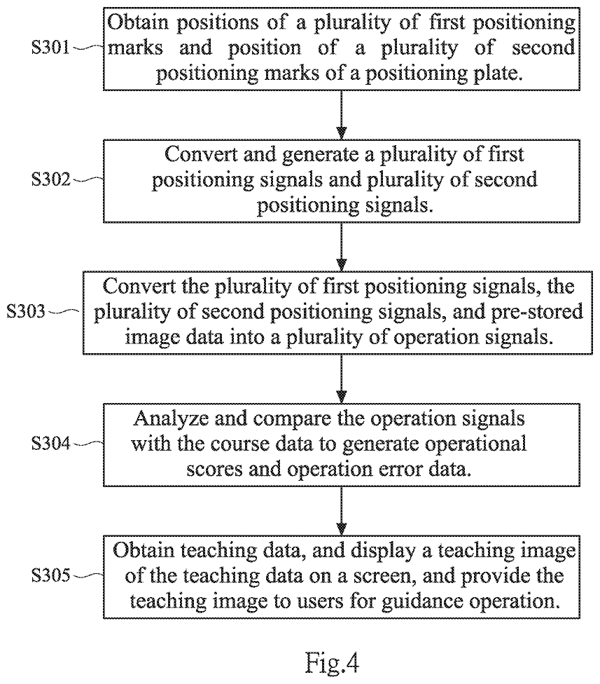

With reference to FIG. 4 for a flow chart of a clinical dental education and training method in accordance with an embodiment of this disclosure, the method is applied in a server and comprises the following steps.

S301: Use an image tracking and capturing system to obtain positions of a plurality of first positioning marks of a handheld positioning portion and positions of a plurality of second positioning marks of a positioning plate by an image tracking and capturing system, wherein the first positioning marks are coupled to a drill portion of the handheld positioning portion.

S302: Convert the positions of the first positioning marks into a plurality of first positioning signals provided for the system to determine the current position of the handheld positioning portion and convert the positions of the second positioning marks into a plurality of second positioning signals provided for the system to determine the current position of a dental model. The first positioning signals are the plurality of first tracking signals transmitted from the plurality of first positioning marks of the handheld positioning portion, and the second positioning signals are the plurality of second tracking signals transmitted from the plurality of second positioning marks of the positioning plate; or the first positioning signals are the first tracking signals transmitted from the image tracking and capturing system to the first positioning marks and reflected by the first positioning marks, and the second positioning signals re the second tracking signals transmitted from the image tracking and capturing system to the second positioning marks and reflected by the second positioning marks. In another embodiment, the first positioning marks and the second positioning mark actively emit a visible light or an invisible light to generate a first positioning signal and a second positioning signal which are captured by the image tracking and capturing system.

S303: Obtain the first positioning signals and the second positioning signals from the image tracking and capturing system and converts the first positioning signals, the second positioning signals and pre-stored image data into a plurality of operation signals (which correspond to a learner's moving path, drilling angle and related information).

S304: Use an AI system data analysis or various algorithms to analyze and compare the operation signals with the pre-stored course data (such as a standard operation method or a recommended operation method) to generate operational scores and operational error data (such as wrong drilling position, depth, or angle, or the level of difference of the wrong drilling position, depth or angle).

S305: Provide teaching data and display a teaching image of the teaching data on screen for the user's guidance operation. Wherein, the display method includes a three-dimensional projection, virtual reality, mixed reality, or light guidance method.

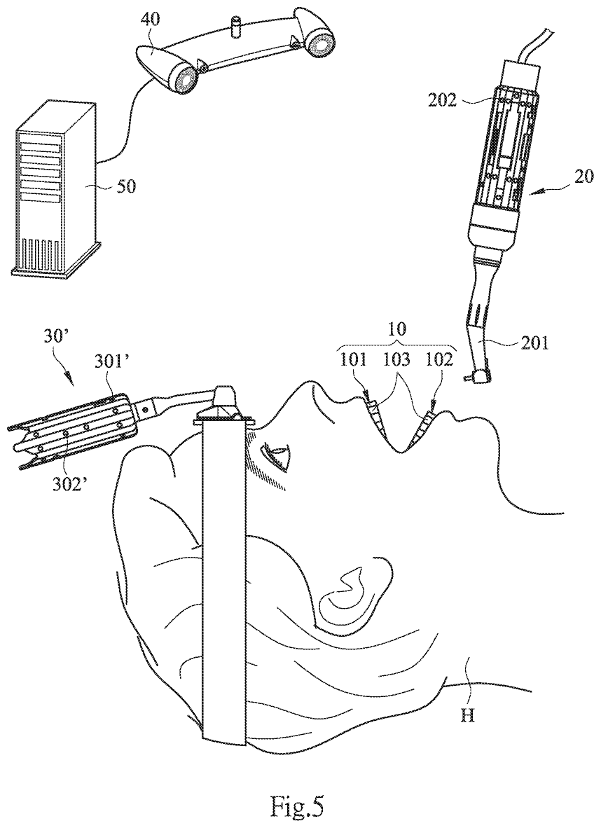

With reference to FIG. 5 for a schematic view of a clinical dental education and training system in accordance with the second embodiment of this disclosure, the difference between FIG. 5 and FIG. 1 resides on the positioning plate 30′ of the dental education and training system 1 of the second embodiment. The positioning plate 30′ comprises a holder 301′ and a plurality of positioning marks 302′. The holder 301′ is fixed onto the head model H, so that the positioning plate 30′ is fixed into the detection area. In the fixing method of this embodiment, the positioning plate 30′ can move with the upper-jaw mold 101. In the fixing method of the previous embodiment, the positioning plate 30 is disposed at the lower-jaw mold 102, so that the positioning plate 30 can move with the lower-jaw mold 102. The appropriate positioning is selected according to the different position of a surgical operation.

The dental education and training system of this disclosure collects and feeds back the operation experience of a learner/user, the course data and the evaluation to an AI system for integration and analysis, and then also feeds back such information to the users to improve their technical deficiencies and the teaching performance. The system provides a guidance function to guide users to make a reasonable determination or decision on the selection of a dental cast, the selection of a drill and guide the users through the operation. The system further provides teaching images or other information to assist the users' operation. The AI system is used to analyze the users' conduct (such as the users' personal habit) by the processes from collecting the operation record of the course and feeding back the information to the development side, and the correction information is fed back to the product. When a user uses the product again, the system will specially remind the user to achieve the effects of correcting the user's conduct and improve the teaching performance.

While the invention has been described by means of specific embodiments, numerous modifications and variations could be made thereto by those skilled in the art without departing from the scope and spirit of the invention set forth in the claims.

What is claimed is:

1. A clinical dental education and training system, comprising:
a handheld positioning portion, comprising a plurality of first positioning marks, and coupled to a drill portion;
a positioning plate, comprising a plurality of second positioning marks and a bracket, and the bracket being combined with a dental model, and the positioning plate being fixed in a detection area;
an image tracking and capturing system, for obtaining positions of the first positioning marks and covering the positions into a plurality of first positioning signals, and obtaining positions of the second positioning marks and converting the positions into a plurality of second positioning signals; and,
a server, pre-stored with image data of the dental model, and coupled to the image tracking and capturing system for obtaining the first positioning signals and the second positioning signals from the image tracking and capturing system and converting the first positioning signals and the second positioning signals into the plurality of operation signals, and analyzing and comparing the operation signals with pre-stored course data to generate operational scores or operational error data accordingly.

2. The clinical dental education and training system as claimed in claim 1, wherein the server has teaching data stored therein, and displays a teaching image included in the teaching data on a screen and provided to the users for a guidance operation.

3. The clinical dental education and training system as claimed in claim 1, wherein the first positioning signals are a plurality of first tracking signals transmitted from the plurality of the first positioning marks of the handheld positioning portion, and the second positioning signals are a plurality of second tracking signals transmitted from a plurality of second positioning marks of the positioning plate; or the first positioning signals are the first positioning marks transmitted to the image tracking and capturing system and the first tracking signals reflected to the first positioning marks, and the second positioning signals are the second positioning marks transmitted from the image tracking and capturing system and the second tracking signals reflected to the second positioning marks.

4. The clinical dental education and training system as claimed in claim 1, wherein the server generates the operational scores or the operational error data according to the difference between the operation signals and the course data; or the server performs a path comparison based on the operation signals and the course data, and converts their differences into the operational scores or the operational error data.

5. The clinical dental education and training system as claimed in claim 1, wherein the server is further coupled to a scanning device via a signal, and the scanning device is provided for scanning the dental model, and sending a scan result to the server.

6. A clinical dental education and training method, comprising:
obtaining positions of a plurality of first positioning marks of a handheld positioning portion and positions of a plurality of second positioning marks of a positioning plate by an image tracking and capturing system, wherein the first positioning marks are coupled to a drill portion of the handheld positioning portion;
converting the positions of the first positioning marks into a plurality of first positioning signals and the positions of the second positioning marks into a plurality of second positioning signals;
obtaining the first positioning signals and the second positioning signals from the image tracking and capturing system and storing the first positioning signals and the second positioning signals into a server, and the server converting the first positioning signals and the second positioning signals into a plurality of operation signals; and
comparing and analyzing the operation signals with the course data to generate operational scores and operational error data.

7. The clinical dental education and training method as claimed in claim 6, further comprising the steps of: accessing teaching data stored in the server, and displaying a teaching image included in the teaching data on a screen and provided to the user for a guidance operation.

8. The clinical dental education and training method as claimed in claim 6, wherein the first positioning signals are the plurality of first tracking signals transmitted from the plurality of first positioning marks of the handheld positioning portion, and the second positioning signals are the plurality of second tracking signals transmitted from the plurality of second positioning marks of the positioning plate; or the first positioning signals are the first tracking signals transmitted from the image tracking and capturing system to the first positioning marks and reflected by the first positioning marks, and the second positioning signals re the second tracking signals transmitted from the image tracking and capturing system to the second positioning marks and reflected by the second positioning marks.

9. The clinical dental education and training method as claimed in claim 6, wherein the operational scores or the operational error data are generated according to the difference between the operation signals and the course data; a path comparison is performed according to the operation signals and the course data, and their differences are converted into the operational scores or the operational error data.

10. The clinical dental education and training method as claimed in claim 6, wherein the server is coupled to a scanning device via a signal, and the scanning device is provided for scanning a dental model to obtain an operation result, and the server compares the operation result with built-in scan data to produce an operation report.
